(19) United States
(12) Patent Application Publication
(10) Pub. No.: US 2022/0214701 A1
(43) Pub. Date: Jul. 7, 2022

(54) AUTONOMOUS VEHICLE AND AUTHENTICATION AGENCY METHOD THEREOF

(71) Applicant: LG ELECTRONICS INC., Seoul (KR)

(72) Inventor: Yongsoo PARK, Seoul (KR)

(73) Assignee: LG ELECTRONICS INC., Seoul (KR)

(21) Appl. No.: 16/485,143

(22) PCT Filed: Jun. 20, 2019
(86) PCT No.: PCT/KR2019/007427

§ 371 Date: Aug. 9, 2019

(51) Int. Cl. G05D 1/10; B64C 39/02; G05D 1/00

(52) U.S. Cl. CPC G05D 1/106; B64C 39/024; B64C 2201/123; B64C 2201/141; G05D 1/0094

(57) ABSTRACT

Disclosed are an autonomous vehicle and an authentication agency method thereof. The autonomous vehicle includes: a controller that outputs a location and a route of the vehicle when an event requiring authentication of a passenger occurs; and an authentication system that sets a preliminary zone on the basis of the location and the route of the vehicle input from the controller, attempts direct authentication of the passenger in the preliminary zone, and performs authentication on the basis of data stored in advance or data received through a network after arriving at an authentication zone outside the vehicle when direct authentication of the passenger is failed, One or more of an autonomous vehicle, an AI device, and an external device may be associated with an artificial intelligence module, a drone ((Unmanned Aerial Vehicle, UAV), a robot, an AR (Augmented Reality) device, a VR (Virtual Reality) device, a device associated with 5G services, etc.

### TECHNICAL FIELD

The present invention relates to an autonomous vehicle and an authentication agency method thereof and, more particularly, to autonomous vehicle and authentication agency method thereof

### BACKGROUND ART

A vehicle is one of transportation that carries users in the vehicle in a desired direction and a car can be representatively exemplified. Vehicles provide convenience for moving to users, but it is required to carefully look at the front area and the rear area while driving. The front area and the rear area may mean driving interference factors such as an object, that is, a person, a vehicle, and an obstacle that approach or are positioned around a vehicle.

An autonomous vehicle can drive itself without intervention of a driver. Many companies have already gone into the autonomous vehicle business and are absorbed in research and development.

### DISCLOSURE

### Technical Problem

Passengers of an autonomous vehicle do not need to intervene driving in driving but can determine a route or purchase a service during autonomous driving. Passenger authentication is required in this process.

Sleeping and driving can be allowed for passengers in an autonomous vehicle. Passengers in an autonomous vehicle may have difficult in normal thinking or may fall into an emergency situation. These passengers may have difficulty in taking authentication or may not be authenticated.

An object of the present invention is to solve the necessities and/or problems described above.

Another object of the present invention is to provide an autonomous vehicle that can provide an authentication agency service to passengers in a situation in which authentication process is difficult, and an authentication agency method thereof.

The objects of the present invention are not limited to the objects described above and other objects will be clearly understood by those skilled in the art from the following description.

### Technical Solution

An autonomous vehicle according to an embodiment of the present invention includes: a controller that outputs a location and a route of the vehicle when an event requiring authentication of a passenger occurs; and an authentication system that sets a preliminary zone on the basis of the location and the route of the vehicle input from the controller, attempts direct authentication of the passenger in the preliminary zone, and performs authentication on the basis of data stored in advance or data received through a network after arriving at an authentication zone outside the vehicle when direct authentication of the passenger is failed,

The authentication zone includes a store or an organization where the event is finished.

An authentication agency method of the autonomous vehicle provides a location-based authentication agency service using the controller and the authentication system.

### Advantageous Effects

Effects of the autonomous vehicle and an authentication method thereof according to the present invention are as follows.

The present invention serves authentication on the basis of route and location area information of an autonomous vehicle.

The prevent invention serves an authentication process that is reliable in a situation in which authentication is difficult to take or cannot be taken from a passenger, thereby being able to provide desired surfaces to the passenger and actively deal with an emergency situation.

The effects of the present invention are not limited to the effects described above and other effects can be clearly understood by those skilled in the art from the following description.

### DESCRIPTION OF DRAWINGS

FIG. 1 is a block diagram of a wireless communication system to which methods proposed in the disclosure are applicable.

FIG. 2 is a diagram showing an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 is a diagram showing a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram illustrating the interior of a vehicle according to an embodiment of the present invention.

FIG. 10 is a block diagram that is referred to for describing an automotive cabin system according to an embodiment of the present invention.

FIG. 11 is a diagram referred to in description of a usage scenario of a user according to an embodiment of the present invention.

FIG. 12 is a flowchart showing an authentication agency method according to an embodiment of the present invention.

FIG. 13 is a diagram showing an authentication attempt control method and an authentication attempt method through an agent in the authentication agency method.

FIG. 14 is a flowchart showing location-based authentication agency, authentication execution, and authentication disallowance processes in authentication availability determination.

FIG. 15 is a flowchart showing in detail a control method of a location-based authentication agency service.

FIG. 16 is a diagram showing an example of an autonomous driving route of a vehicle and an authentication zone location.

FIG. 17 is a diagram showing an example of an authentication zone and a preliminary zone.

FIGS. 18 to 21 are diagrams showing example of a location-based authentication agency service that is provided for various passengers who have difficulty in taking authentication or cannot take authentication in person.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Hereafter, 5G communication (5^{th} generation mobile communication) that a device and/or an AI processor, which requires AI-processed information, requires is described through a paragraph A to a paragraph H.

A. Example of block diagram of UE and 5G network

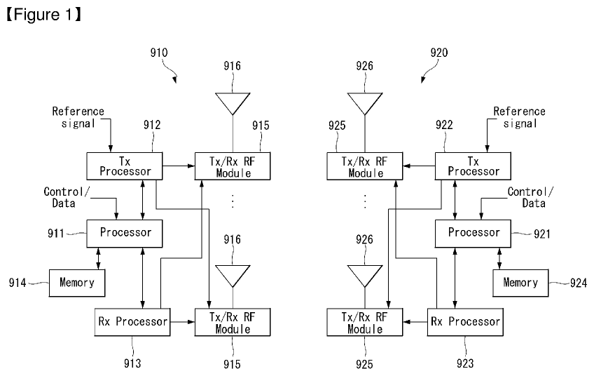

FIG. 1 is a block diagram of a wireless communication system to which methods proposed in the disclosure are applicable.

Referring to FIG. 1, a device (autonomous vehicle) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The RX processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

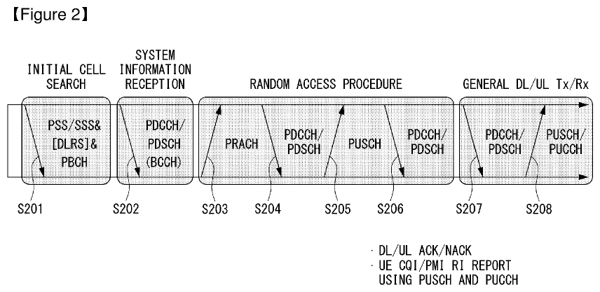

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

The UE receives an NZP CSI-RS resource set IE including an RRC parameter with respect to ‘repetition’ from a BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam (when the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

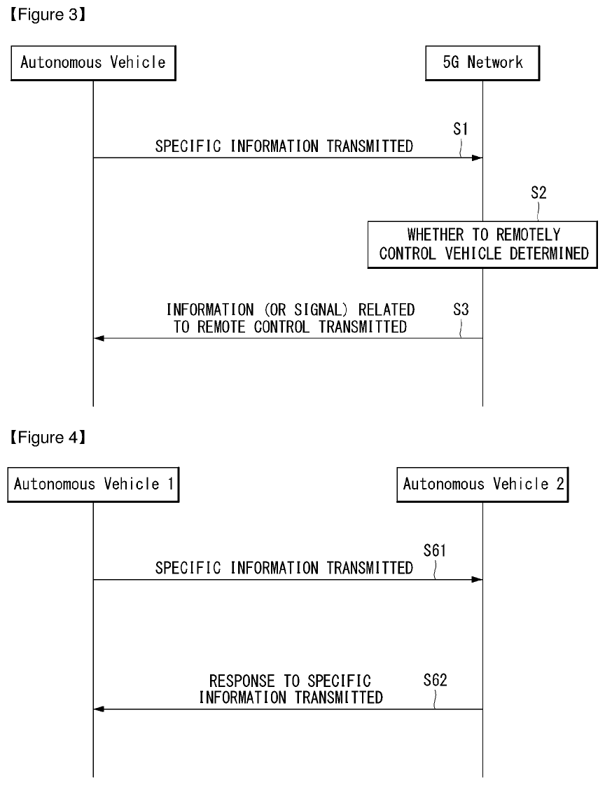

FIG. 3 shows an example of basic operations of an autonomous vehicle and a 5G network in a 5G communication system.

The autonomous vehicle transmits specific information to the 5G network (S1). The specific information may include autonomous driving-related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, a autonomous vehicle can receive DownlinkPreemption IE from the 5G network after the autonomous vehicle performs an initial access procedure and/or a random access procedure with the 5G network Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

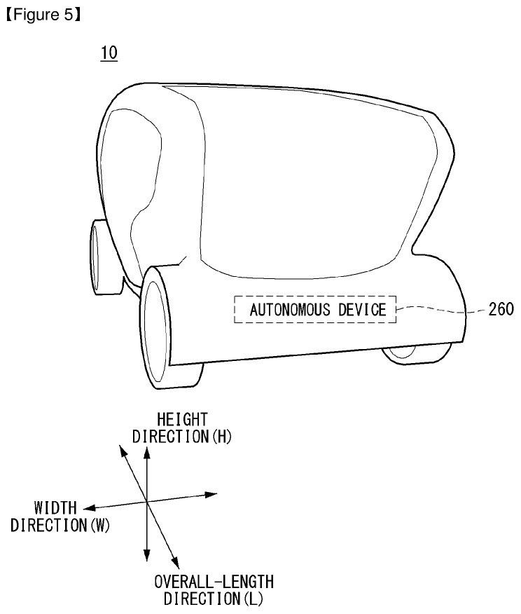

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The 5G communication technology described above can be applied in combination with methods to be described and proposed below in the present invention, or may a supplement for realizing or clarifying the technological features of the methods proposed in the present invention.

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

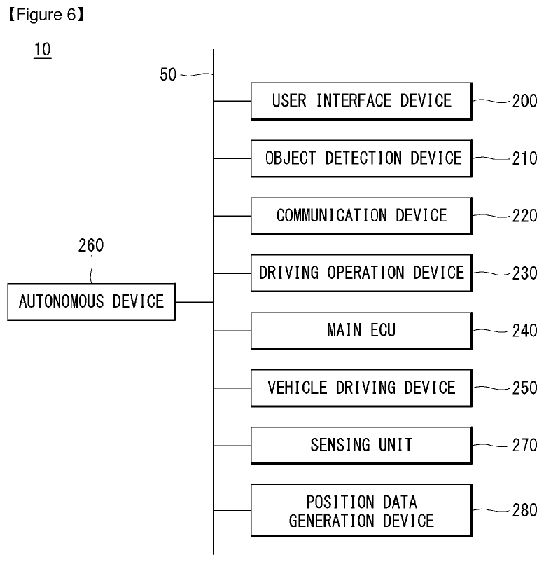

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The vehicle driving device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device, and a suspension driving control device. Meanwhile, the safety device driving control device may include a seat belt driving control device for seat belt control.

The vehicle driving device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for driving along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor, and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, and data of a pressure applied to a brake pedal, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

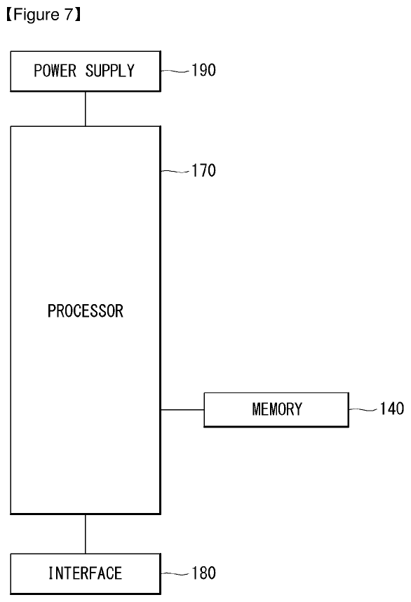

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected with the processor 170. The memory 140 can store basic data about units, control data for operation control of units, and input/output data. The memory 140 can store data processed in the processor 170. Hardware-wise, the memory 140 may be configured using at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. Depending on embodiments, the memory 140 may be classified as a lower configuration of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can supply power to the autonomous vehicle 260. The power supply 190 can be provided with power from a power source (e.g., a battery) included in the vehicle 10 and supply the power to each unit of the autonomous device 260. The power supply 190 can operate according to a control signal supplied from the main ECU 140. The power supply 190 may include a switched-mode power supply (SMPS).

The processor 170 can be electrically connected to the memory 140, the interface 180, and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal, and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190, and the processor 170 may be electrically connected to the PCB.

(4) Operation of Autonomous Device

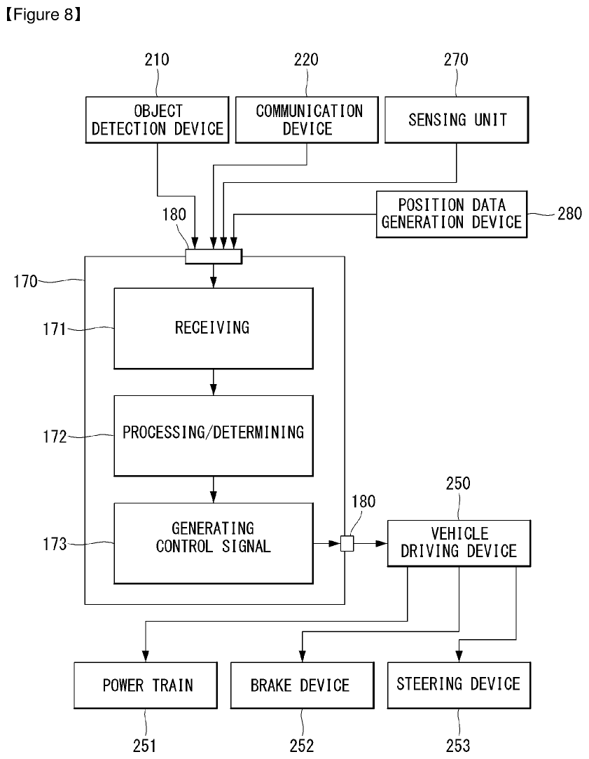

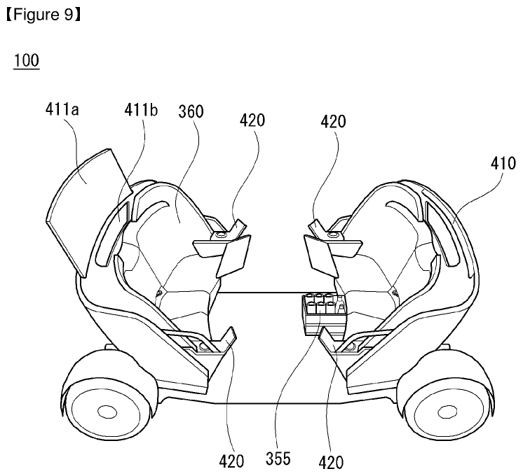

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of driving situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined driving route. The horizon may refer to a point at which the vehicle can arrive after a predetermined time from the position at which the vehicle 10 is located along a predetermined driving route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

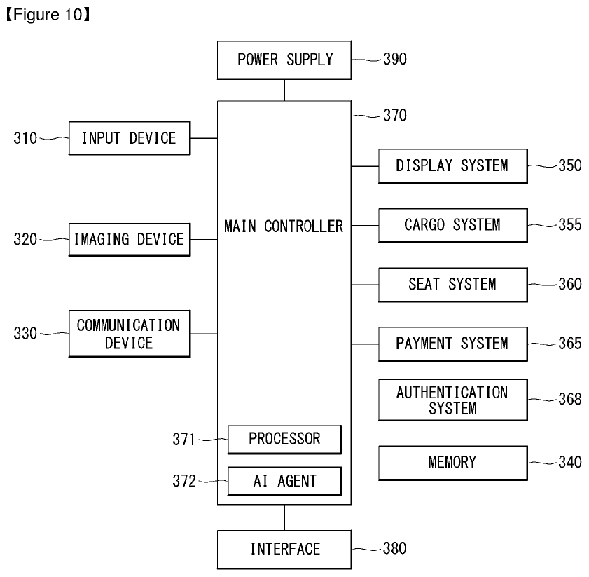

FIG. 9 is a diagram showing the interior of the vehicle according to an embodiment of the present invention. FIG. 10 is a block diagram referred to in description of a cabin system for a vehicle according to an embodiment of the present invention.

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input.

According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

The display system 350 can display graphic objects. The display system 350 may include at least one display device. For example, the display system 350 may include a first display device 410 for common use and a second display device 420 for individual use.

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to driving situation information of the vehicle 10. The driving situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

An authentication system 368 processes authentication of a passenger when authentication of a user or passenger in the vehicle 10. The authentication system 368 processes authentication on the basis of authentication information input by an event passenger who requires authentication of a passenger.

An event that requires authentication is a situation when a passenger orders a product or a service or changes a route or a situation when an emergency situation occurs. The emergency situation, for example, may be a state in which a passenger has to be sent to the emergency room of a hospital due to bad health of the passenger. The authentication information may be authentication information for user authentication such as user's biological information or user's profile information.

The main controller 370 can monitor in real time the state of each passenger by analyzing images obtained from a camera in the vehicle 10 and can determine the state of the passenger by connecting with an AI processor. The main controller 37 can provide data indicating the state of a passenger to the authentication system 368 together with event information requiring authentication of the passenger and the location and route of the vehicle 10. The event information may include order information of a user and emergency situation information.

The authentication system 368 performs a location-based authentication agency service in a situation in which direct authentication of a passenger is difficult or impossible in an event requiring authentication of the passenger. The location-based authentication agency service can automatically process authentication instead of a passenger using biological information or digital information (or user profile) of authentication information users stored in advance or can process authentication on the basis of authentication information of an agent under permission of agents (or guardians) stored in advance.

The authentication information processed by the authentication system 368 and the authentication process result can be stored in the memory 340 of the vehicle 10 and can be stored in a database connected to an external device through a network. The authentication process result processed by the authentication system 368 can be transmitted to the payment system 365.

The main controller 370 can determine a passenger state from interior images of the vehicle 10 taken by an interior camera and can transmit the passenger state to the authentication system 368. The authentication system 368 determines whether direct authentication of a passenger is difficult, and can process authentication on the basis of authentication information of passenger or agents stored in advance when determining that direct authentication of the passenger is difficult or impossible.

The authentication system 368 can process authentication in connection with an authentication system of an external device (or server) through the network.

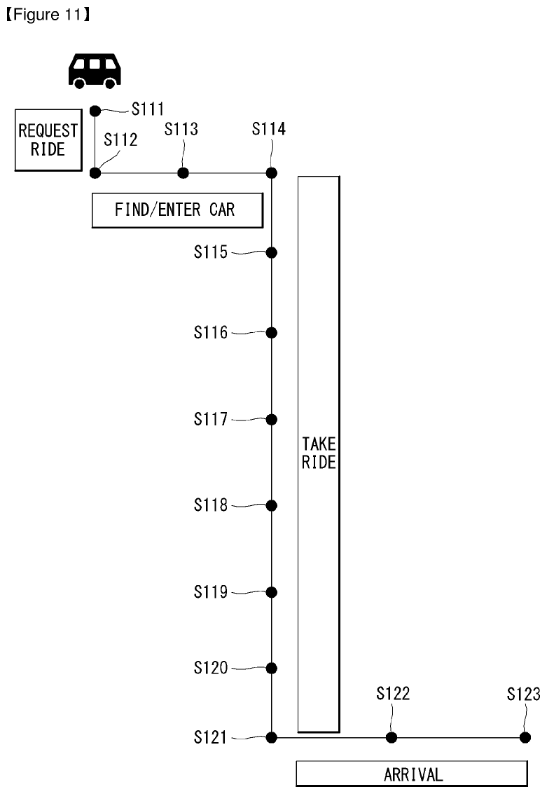

FIG. 11 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

An authentication agency method of an autonomous vehicle according to an embodiment of the present invention can serve authentication for a passenger on the basis of information of the state of the passenger in the vehicle, an autonomous driving route, and the location of the vehicle.

When the authentication system 368 determines that it is a state in which direct authentication of a passenger is difficult in a situation in which it is required to receive authentication of a passenger (user), the authentication system 368 can extract data for authentication by selecting information for authentication of the current passenger from authentication information of passengers or agents (guardians) stored in advance.

The authentication system 368 can perform authentication availability separately into authentication execution, authentication disallowance, and a location-based authentication agency process in consideration of the relevance between the authentication information of a passenger to be authenticated and the current location and route of a vehicle. The authentication execution is a case in which authentication is succeeded in accordance with valid authentication information and the authentication information is stored. The authentication disallowance is a case in which authentication fails. The location-based authentication agency process can attempt direct authentication of a passenger and perform authentication on the basis of past authentication information of a passenger or authentication information of an agent in an authentication zone in accordance with the location during autonomous driving of the vehicle 10. The past authentication information of a user may be data of past authentication information stored in the memory 340 of the vehicle 10 or the database of an external device (server) connected through the network. The vehicle can transmit the authentication information to the external device (server) or can download authentication information from the external device through the network. The specific information in FIGS. 3 and 4 may include one or more of items of passenger state information obtained from the AI processor.

The main controller 370 can limit vehicle control by the passenger not allowed for authentication on the basis of the authentication result received from the authentication system 368. For example, the main controller 370 can limit or prohibit a purchase service, a route change service, etc. for the passenger disallowed for authentication or failed in authentication.

The present invention may change the control intensity of an authentication attempt in accordance with the location of the vehicle 10 in a situation in which direct authentication of a current passenger is difficult. When an event requiring authentication of a passenger occurs and authentication through the passenger is impossible regardless of the passenger's state, the authentication system 368 can set a preliminary zone on a route going to an authentication zone, can attempt authentication for the passenger, and can perform authentication through data selected from the past authentication information of the passenger when authentication is failed.

The authentication system 368 can receive state information of a passenger from the main controller 370, and can perform the location-based authentication agency service when determining that it is a state in which the passenger has difficulty in performing authentication or cannot perform authentication in person.

The location-based authentication agency service of the present invention may be set for a preliminary zone and an authentication zone. The preliminary zone is an area on a driving route for determining authentication availability in a situation in which authentication of a passenger is required. The authentication zone is an area where an event requiring authentication of a passenger is finished. For example, the authentication zone may be a store where a passenger receives a product or a service that the passenger has ordered in the vehicle 10 or a relevant organization that transfers a passenger to a predetermined relevant organization to deal with an emergency situation. The authentication zone may be a stopover on the route of the vehicle 10 that is autonomously driven, or a destination after a change.

The preliminary zone may be divided into two or more zones, depending on the distance from the authentication zone. For example, the preliminary zone may be divided into a first preliminary zone and a second preliminary zone. The second preliminary zone may be close to the authentication zone in comparison to the first preliminary zone. The range of the preliminary zone may be adjusted in accordance with urgency and importance of authentication. For example, in a situation in which urgency and importance of authentication are high, the authentication system 368 can make the range of the preliminary zone from the authentication zone large. The range of the preliminary zone is a size that is determined in accordance with the distance or radius from the center of the authentication zone.

When an event requiring authentication of a passenger occurs, the main controller 370 can virtually divide the area from the current location of the vehicle to the authentication zone into two or more preliminary zones. The event requiring authentication of a passenger, for example, may be a situation in which a passenger purchases a product or a service or an emergency situation for a passenger. The main controller 370 attempts authentication to a passenger to be authenticated when the vehicle 10 passes through the preliminary zone in accordance with autonomous driving.

The authentication system 368 can attempt authentication to the passenger to be authenticated with larger control intensity as the vehicle comes closer to the authentication zone from the preliminary zone by controlling the main controller 370. When the location-based authentication agency service is performed, the main controller 370 can change the control intensity for inducing direct authentication of a passenger, depending on the location of the vehicle 10.

The authentication system 368 can attempt authentication for inducting direct authentication of the passenger using output through a user interface device such as a speaker, a display, vibration, or Haptic to the passenger to be authenticated while the vehicle 10 passes through the preliminary zone. The main controller 370 can control the output intensity of the user interface to be larger as the vehicle comes closer to the authentication zone from the preliminary zone.

The main controller 370 can provide the current location and route of the vehicle 10 to the authentication system 368 together with the information of the passenger to be authenticated. The authentication system 368 can determine the relevance between the information of the passenger to be authenticated and the current location and route of the vehicle 10 and can use the relevance for the location-based authentication agency service. The authentication system 368 can determine relevance by giving marks to the relevance between an event requiring authentication and the current location and route of the vehicle 10.

The main controller 370 may include an AI (Artificial Intelligence) processor. The AI processor can provide authentication information, which is repeatedly selected or repeatedly stored for the same location and route, first to the authentication system 368 when there is a request from the authentication system 368.

Hereafter, the authentication agency method of an autonomous vehicle according to an embodiment of the present invention will be described in detail in association with drawings.

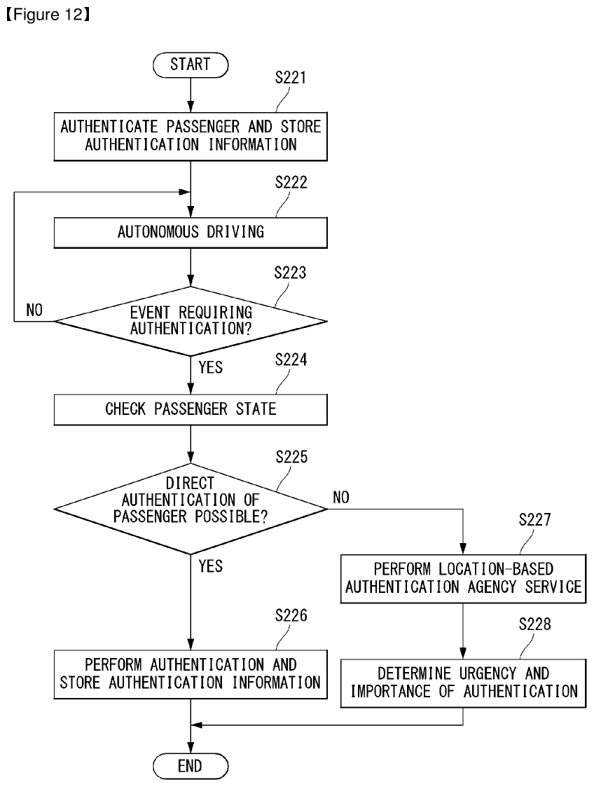

FIG. 12 is a flowchart showing an authentication agency method according to an embodiment of the present invention. The agency method can be processed by the system shown in FIG. 10.

Referring to FIG. 12, a passenger can get in the vehicle 10 through an authentication procedure. The authentication system 368 stores authentication information of the passenger to the memory 340 (S221).

The vehicle 10 sets an autonomous driving route to the destination of the passenger and plans autonomous driving. The vehicle 10 is driven along the driving route with the passenger therein in an autonomous driving mode (S222).

An event requiring authentication may occur by the passenger during autonomous driving of the vehicle 10. For example, since the passenger does not intervene in driving of the vehicle 10 that is driven in the autonomous driving mode, the passenger can order a product or a service from the cargo system 355 of the vehicle 10 or can purchase a product or a service that is provided at an authentication zone outside the vehicle. For example, the passenger can order food that is prepared by the cargo system 355 and order food from Macdonald or Starbucks through a network and can receive the ordered food through a drive-thru service that is provided at a store in a specific area. When the passenger suddenly drops down on the floor in the vehicle, the vehicle 10 can determine that it is an emergency system, change the route to a hospital, and provide an emergency situation alert to the authentication system 368 together with the passenger state.

When an event requiring authentication of the passenger occurs, the autonomous driving route can be changed due to addition of a stopover or a changed destination. The main controller 370 can check the state of the passenger to be authenticated and provide the state to the authentication system 368 (S223).

When valid authentication information is input from the passenger to be authenticated, the authentication system 368 can perform authentication and store authentication information to the memory 380 (S226). The authentication system 368 checks the passenger state, and then performs the location-based authentication agency service when determining that the passenger has difficulty in taking authentication or cannot take authentication in person (S227).

The location-based authentication agency service performs authentication by providing past authentication information of the passenger to the authentication system 368 on behalf of the passenger to be authenticated, in which the location-based authentication agency service can attempt direct authentication of the passenger in a preliminary zone and perform authentication in an authentication zone on the basis of the past authentication information of the passenger. When it is determined that direct authentication of a user is impossible even in the authentication zone, the location-based authentication agency service can process authentication on the basis of the authentication information stored in the memory. The location-based authentication agency service can select authentication availability by determining urgency and importance of authentication (S228). Further, the location-based authentication agency service can determine authentication availability by determining validity (or reliability) of a response from the passenger.

The authentication result may be one of authentication execution, authentication disallowance, and ‘unknown’. When it is ‘unknown’, the location-based authentication agency service is performed.

The authentication system 368 can determine authentication availability by determining the validity of a response from the user even if direction authentication of the passenger is possible. The validity of a response from a passenger can be determined as a low level when responses from a passenger to repeated attempts for authentication of the passenger is not consistent or when a passenger who has no past authentication information responds. The urgency and importance of authentication and the validity of a response from a passenger can be quantified by giving marks in accordance with the state of the passenger, an emergency situation, and response reliability of the passenger. Accordingly, the authentication system 368 can determine urgency and importance of authentication and the validity of a response from a passenger through quantitative estimation calculated by a predetermined algorithm.

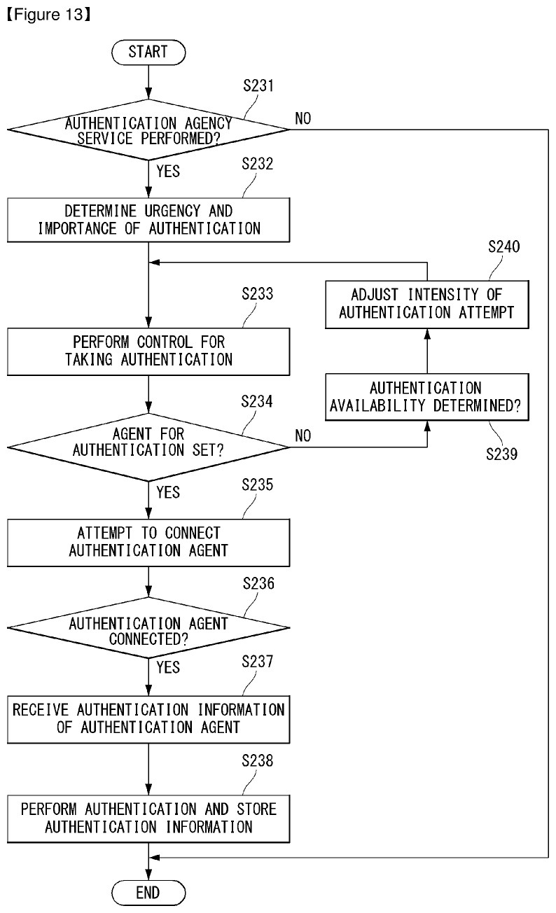

FIG. 13 is a diagram showing an authentication attempt control method and an authentication attempt method through an agent in the authentication agency method.

Referring to FIG. 13, the main controller 370 determines urgency and importance of authentication (S231 and S232).

The main controller 370 performs control for authentication (S233). The main controller 370 can determine the relevance between a current event requiring authentication and the current location and route of the vehicle 10. When the relevance between a current event requiring authentication and the current location and route of the vehicle 10 is high, the main controller 370 can increase the control intensity of an authentication attempt higher than the case when the relevance is low, as the current location and route of the vehicle 10 come closer to an authentication zone where a product or a service ordered by a passenger is provided.

The main controller 370 determines the state of a passenger, and when the passenger cannot provide authentication information in person, that is, when direct authentication of the passenger is difficult or impossible, the main controller 370 determines whether an agent for authentication of the passenger has been set (S234). The main controller 370 determines an agent associated with the passenger using one or more of predetermined agent information, riding information of the passenger, and past authentication information in the situation in which direct authentication of the passenger is difficult or impossible. The main controller 370 attempts to connect with the agent on the basis of information allowing for connection with the agent. The information allowing for connection with an agent may be a phone number, an email address, an SNS account, etc. When the main controller 370 is connected with a terminal of the agent through a network, the main controller 370 receives authentication information of the agent or selects past authentication information of the agent under permission of the agent and provides authentication information to the authentication system 368 (S237).

The authentication system 368 performs authentication on the basis of the authentication information of the agent and stores the authentication information (S238). The authentication system 368 can store the authentication information to the memory 340 together with information of the event requiring authentication and the current location and route of the vehicle 10.

When there is no agent in step S234, the main controller 370 receives an authentication result from the authentication system 368 and determines authentication availability (S239). When it is processed as ‘unknown’ in the determination of authentication availability in step S239, the main controller 370 attempts direct authentication of the passenger in a preliminary authentication zone set on the basis of the current location and route of the vehicle 10 that is autonomously driven by performing the location-based authentication agency service. When performing the location-based authentication agency service, the main controller 370 can perform step S233 by adjusting the control intensity of the authentication attempt in the preliminary authentication zone (S239 and S240).

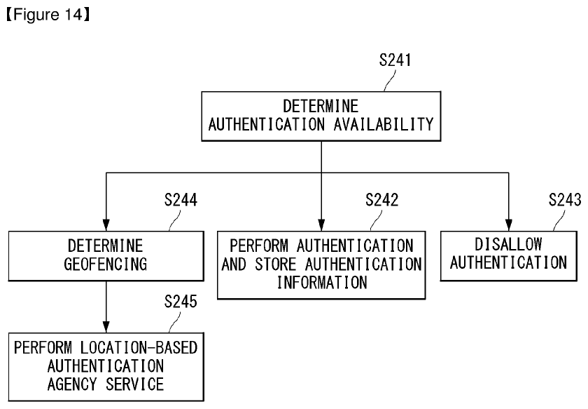

FIG. 14 is a flowchart showing location-based authentication agency, authentication execution, and authentication disallowance processes in authentication availability determination.

Referring to FIG. 14, the authentication system 368 receives the relevance between the information of an event requiring authentication and the current location and route of the vehicle, the urgency and importance of authentication, and authentication information from the main controller 370, and determines authentication availability. The authentication information may be any one of authentication information received from a passenger or an agent and past authentication information stored in a memory.

The authentication availability determination may be divided into authentication execution and authentication information storage (S242), authentication disallowance (S243), Geofencing determination (S244), etc. Step S242 is a case when authentication is valid and authentication is succeeded. In step S244, a preliminary zone is set to perform the location-based authentication agency service in an unknown state in which authentication is not attempted for an event requiring authentication.

The main controller 370 performs the location-based authentication agency service in step S244 that is a situation in which direct authentication of a passenger is difficult when attempting authentication (S245). The location-based authentication agency service sets an authentication zone and a preliminary zone around the authentication zone on the basis of the relevance between the event requiring authentication and the current location and route of the vehicle 10. The preliminary zone is an area where the relevance between the event requiring authentication and the current location and route of the vehicle 10 is high in comparison to the area where authentication is not required. The preliminary zone may be set as a concentric circular area around an authentication zone T2, as illustrated in FIG. 17. The size or radius of the preliminary zone may change in accordance with the urgency and importance of authentication. For example, the higher the urgency and importance of authentication, the larger the preliminary zone may be. The location-based authentication agency service repeatedly attempts direct authentication of a passenger while adjusting the control intensity until it receives authentication information from the passenger in the preliminary zone.

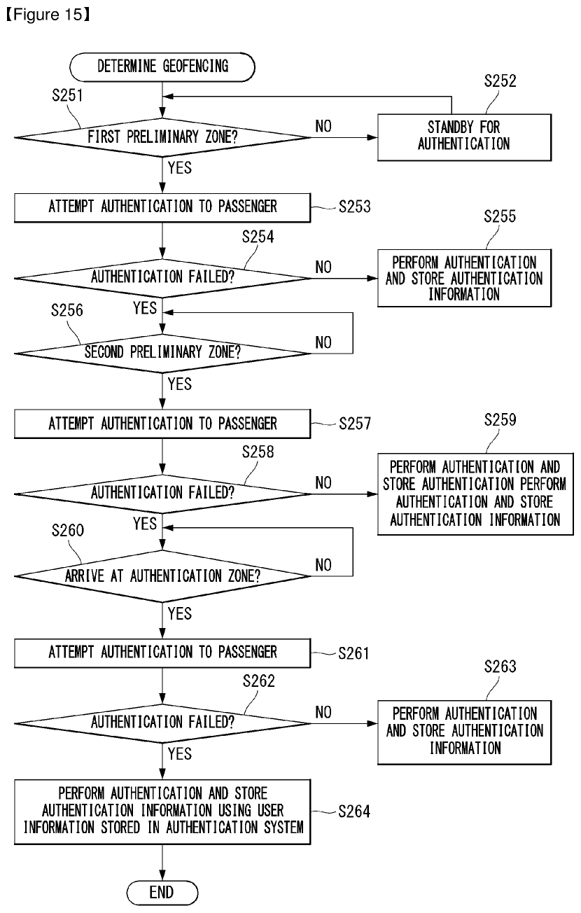

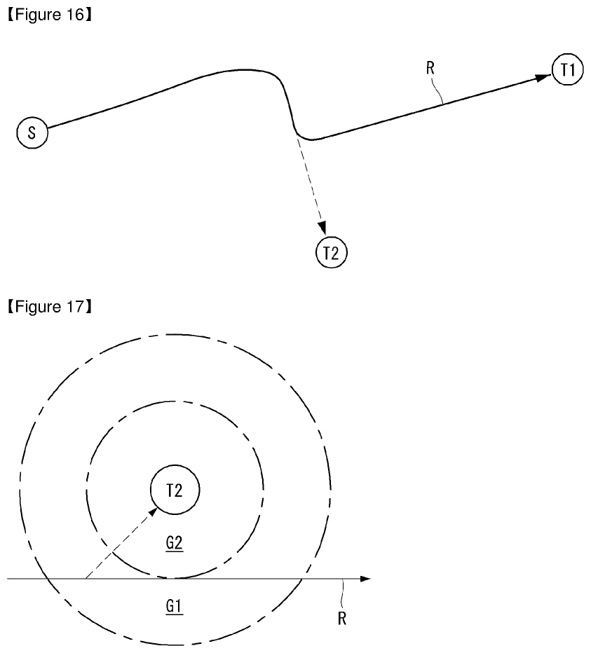

FIG. 15 is a flowchart showing in detail a control method of a location-based authentication agency service. FIG. 16 is a diagram showing an example of an autonomous driving route of a vehicle and an authentication zone location. FIG. 17 is a diagram showing an example of an authentication zone and a preliminary zone.

Referring to FIGS. 15 to 17, the main controller 370 sets a preliminary zone where authentication of a passenger is attempted, by processing Geofencing determination to perform the location-based authentication agency service.

The preliminary zone, as illustrated in FIGS. 16 and 17, can be set on the basis of the route R of the vehicle 10 that is autonomously driven and the current location of the vehicle 10. In FIG. 16, S is a start point and T1 is a destination. T2 is a stopover or a changed destination. T2 may be an authentication zone location of a store where a product or a service ordered by a passenger can be provided when an event requiring authentication or a relevant organization that receives a passenger in an emergency situation.

The preliminary zone may be set as a concentric circle around the authentication zone T2, as illustrated in FIG. 17. The preliminary zone is an area close to the authentication zone T2 outside the authentication zone T2. The range of the preliminary zone may be defined as the radius from the center of the authentication zone T2.

The preliminary zone may be defined into a first preliminary zone G1 and a second preliminary zone G2. The second preliminary zone may be close to the authentication zone in comparison to the first preliminary zone. The range of the preliminary zone may be adjusted in accordance with urgency and importance of authentication. The first preliminary zone G1 is set as an area not departing from a route, including the route R to the first destination T1.

The second preliminary zone G2 is set as an area between the first preliminary zone G1 and the authentication zone T2. The second preliminary zone G2 is close to the authentication zone T2 in comparison to the first preliminary zone G1. The second preliminary zone G2 is an area that passes through the route to the authentication zone T2 while departing from the route R to the first destination T1. The may controller 370 can increase the control intensity in the second preliminary zone G2 higher than that in the first preliminary zone G1.

The authentication system 368 stands by without attempting authentication of a passenger to be authenticated until the vehicle 10 that is autonomously driven along the route R enters the first preliminary zone G1.

The authentication system 368 attempts authentication to the passenger to be authenticated with the control intensity set by the main controller 370 when the vehicle 10 that is being driven on the existing route R is positioned on the first preliminary zone G1 (S151 and S253). For example, the authentication system 368 can provide a message saying attempts of authentication to the passenger to be authenticated through a user interface device that is disposed for each passenger such as a display, a speaker, and seat vibration. The authentication system 368 can repeatedly attempt authentication of the passenger to be authenticated with predetermined time intervals in the first preliminary zone G1.

When valid authentication information is input from the passenger in the first preliminary zone G1, the authentication system 368 performs authentication and stores authentication information to the memory 340 (S254 and S255). The authentication system 368 can transmit the authentication information to a database connected to an external device through a network. The authentication information is stored with the event requiring authentication and the location and route of the vehicle 10, thereby being able to be used for an AI learning process and the next authentication attempt.

Direct authentication of a passenger may fail without a response from the passenger to be authenticated until the vehicle 10 enters the second preliminary zone G2 through the first preliminary zone G1. The vehicle 10 can enter the second preliminary zone G1 along a route changed to go to the authentication zone G2 departing from the existing route R (S253 and S254).

While the vehicle 10 is driven in the second preliminary zone G2, the authentication system 380 attempts authentication to the passenger to be authenticated with control intensity set by the main controller 370 (S256 and S257). The main controller 370 can further increase the control intensity of an authentication attempt in the second preliminary zone G2. For example, the authentication system 368 can output a message saying an attempt of authentication to the passenger to be authenticated by adding a user interface device for attempting authentication of a passenger or increasing the output intensity of a user interface device. The authentication system 368 can repeatedly attempt authentication of the passenger to be authenticated with predetermined time intervals in the second preliminary zone G2. The authentication system 368 can express a purchase reservation or an emergency situation by transmitting order information, which is input when there is a purchase request from a user in the second preliminary zone G2, to a store or an organization in the authentication zone T2.

When valid authentication information is input from the passenger in the second preliminary zone G2, the authentication system 368 performs authentication and stores authentication information to the memory 340 (S258 and S259). The authentication information is stored with the event requiring authentication and the location and route of the vehicle 10, thereby being able to be used for an AI learning process and the next authentication attempt.

Direct authentication of a passenger may fail without a response from the passenger to be authenticated until the vehicle 10 enters the authentication zone T2 through the second preliminary zone G2. The vehicles 10 informs a store or an organization in the authentication zone T2 of arrival when entering the authentication zone T2, and attempts authentication to the passenger to be authenticated (S258, S260, and S261). The main controller 370 can increase the control intensity of an authentication attempt when the vehicle enters the authentication zone T2. When valid authentication information is input from the passenger in the authentication zone T2, the authentication system 368 performs authentication and stores authentication information to the memory 340 (S262 and S263). The authentication system 368 can transmit the authentication information to a database connected to an external device through a network.

When direct authentication of the passenger fails because there is no response even though the authentication system 368 has attempted authentication to the passenger in the authentication zone T2, the authentication system 368 can read out past authentication information of the passenger from the memory or can download and receive the past authentication information through a network. If there is no response from the passenger even though authentication has been attempted to the passenger until the vehicle arrives at the authentication zone T2 through the preliminary zones G1 and G2, it may be a situation in which the passenger cannot perform authentication by himself/herself in person. If there is no response from a passenger when attempting authentication to the passenger in the authentication zone T2, the authentication system 368 performs authentication on the basis of valid past authentication information by inquiring past authentication information of the passenger and then stores the authentication information to the memory (S262 and S264). The authentication system 368 can transmit the authentication information to a database connected to an external device through a network.

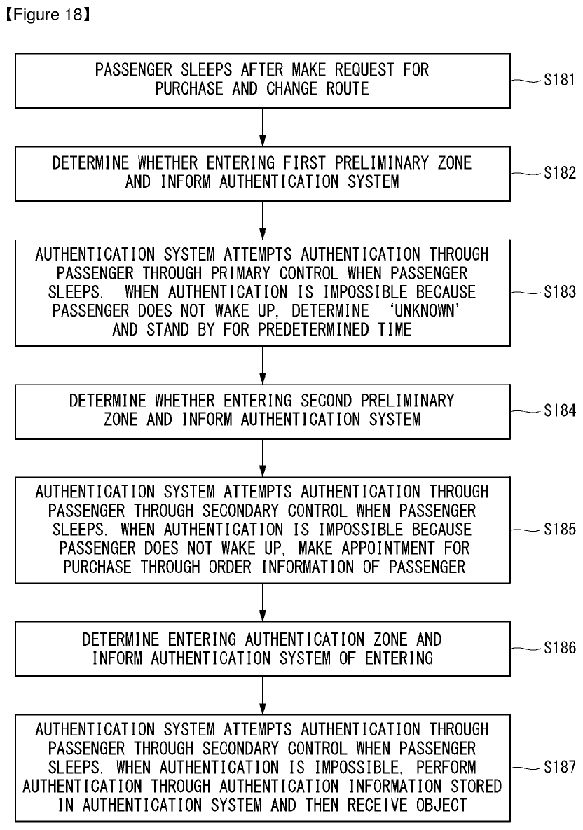

FIGS. 18 to 21 are diagrams showing example of a location-based authentication agency service that is provided for various passengers who have difficulty in taking authentication or cannot take authentication in person.

Referring to FIG. 18, when a passenger in an autonomous vehicle sleeps after making a purchase request by ordering a product, the authentication system 368 can set preliminary zones G1 and G2 and perform the location-based authentication agency service.

A passenger may sleep after making a purchase request by ordering a product and changing a route to an authentication zone (S181). The main controller 370 monitors the current location and route of the vehicle 10, and when the vehicle 10 that is autonomously driven enters the first preliminary zone G1, the main controller 370 informs the authentication system 368 of entering of the vehicle (S182).

While the vehicle 10 is autonomously driven in the first preliminary zone G1, the authentication system 368 determines that the passenger is sleeping on the basis of a passenger state received from the main controller 370 and attempts authentication through the passenger through primary control. The primary control may be set at a weak control level that calls the name of the passenger through a speaker. When direct authentication of the passenger is impossible because the passenger does not wake up, the authentication system 368 processes this situation as “unknown” and stands by for a predetermined period (S183). While the vehicle 10 is driven along the route R in the first preliminary zone G1, the authentication system 368 may repeatedly attempt authentication to the passenger until the passenger wakes up and provides authentication information in person.

The authentication system 368 can repeatedly attempt authentication through the passenger at the same control level as that in the first preliminary zone or can gradually increase the control intensity.

The main controller 370 monitors the current location and route of the vehicle 10, and when the vehicle 10 that is autonomously driven enters the second preliminary zone G2, departing from the existing route R, the main controller 370 informs the authentication system 368 of entering of the vehicle (S184).

While the vehicle 10 is autonomously driven in the second preliminary zone G2, the authentication system 368 determines that the passenger is sleeping on the basis of a passenger state received from the main controller 370 and attempts authentication through the passenger through secondary control. The secondary control attempts authentication through the passenger by increasing the control intensity, calling the name of the passenger through a speaker, and vibrating the seat in which the passenger sits. When determining that authentication through the passenger is impossible in the second preliminary zone, the authentication system 368 makes an appointment for purchase by transmitting order information of the passenger to a store in the authentication zone T2 (S185).

The main controller 370 monitors the current location and route of the vehicle 10, and when the vehicle 10 that is autonomously driven arrives at the authentication zone T2, the main controller 370 informs the authentication system 368 of arrival of the vehicle (S186).

When the vehicle 10 arrives at the authentication zone T2, the authentication system 368 attempts authentication through third control to the sleeping passenger. The third control attempts authentication through the passenger by further increasing the control intensity, calling the name of the passenger through a speaker, vibrating the seat in which the passenger sits, and turning on/off light radiated to the passenger. When determining that direct authentication through the passenger is impossible even after arriving at the authentication zone T2, the authentication system 368 receives the product ordered by the passenger by selecting data necessary for authentication from past authentication information of the passenger stored in advance in the memory or past authentication information received from a network and then performing authentication on the basis of the data (S187).

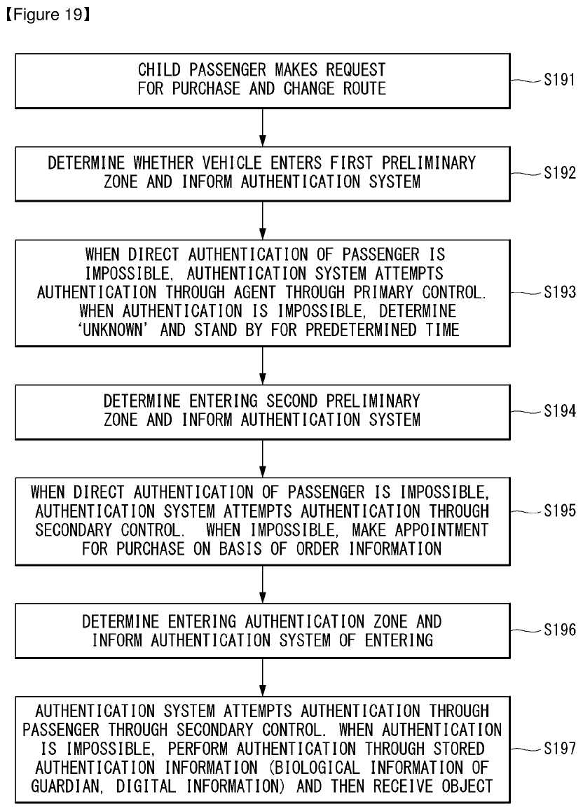

Referring to FIG. 19, a passenger with a selected agent, for example, a minor or a child gets in the vehicle 10. A child in an autonomous vehicle can order a product and change a route for a request for purchase and using a toilet (S191). In this case, an authentication zone may be a convenient store drive-thru.

The main controller 370 monitors the current location and route of the vehicle 10, and when the vehicle 10 that is autonomously driven enters the first preliminary zone G1, the main controller 370 informs the authentication system 368 of entering of the vehicle (S192).

While the vehicle 10 is autonomously driven in the first preliminary zone G1, the authentication system 368 determines that a passenger to be authenticated is a child on the basis of a passenger state received from the main controller 370 or the information of the passenger to be authenticated, and connects with an agent (or guardian) through a network, thereby attempting authentication through the agent. When the agent is not connected, the authentication system 368 processes this situation as “unknown” and stands by for a predetermined period (S193). While the vehicle 10 is driven along the route R in the first preliminary zone G1, the authentication system 368 may repeatedly attempt connection with the agent until the agent is connected.

The main controller 370 monitors the current location and route of the vehicle 10, and when the vehicle 10 that is autonomously driven enters the second preliminary zone G2, departing from the existing route R, the main controller 370 informs the authentication system 368 of entering of the vehicle (S194).

While the vehicle 10 is autonomously driven in the second preliminary zone G2, the authentication system 368 attempts authentication through an agent by connecting with the agent or a secondary agent (or secondary guardian). When failing in authentication through an agent in the second preliminary zone, the authentication system 368 shows specifications of the order to the child to be authenticated and then makes an appointment for purchase by transmitting the order information of the child to a store in the authentication zone T2 (S195).

The main controller 370 monitors the current location and route of the vehicle 10, and when the vehicle 10 that is autonomously driven arrives at the authentication zone T2, the main controller 370 informs the authentication system 368 of arrival of the vehicle (S196).

When the vehicle 10 arrives at the authentication zone T2, the authentication system 368 attempts to connect again with the agent(s) of the child to be authenticated. When determining that direct authentication through the agent is impossible even after arriving at the authentication zone T2, the authentication system 368 receives the product ordered by the child by selecting data necessary for authentication from past authentication information of the agent stored in advance in the memory or past authentication information received from a network and then performing authentication on the basis of the data (S197).

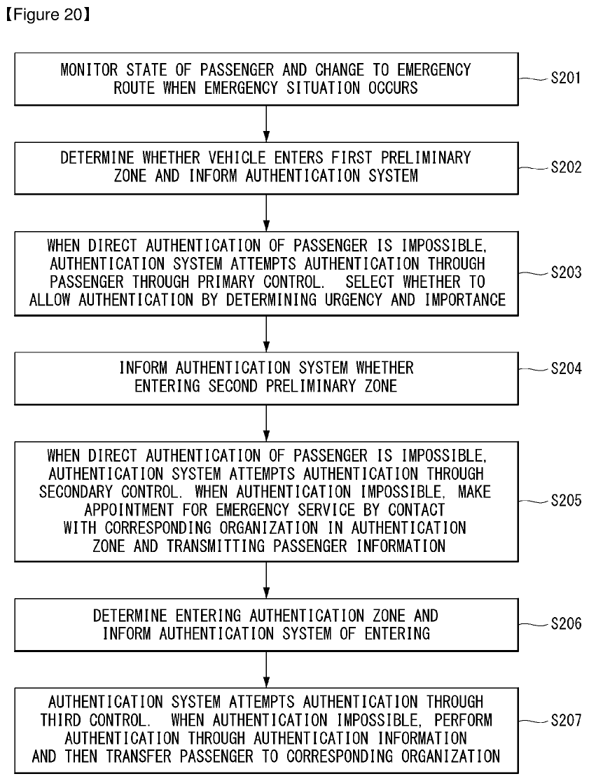

Referring to FIG. 20, a passenger dropping down or abnormally acting may be observed in an autonomous vehicle. In this case, the main controller 370 determines that it is an emergency situation by determining the state of the passenger through an AI agent, searches for a surrounding relevant organization set in advance for emergency situations, and changes the route to a route going to the relevant organization (S201).

The authentication system 368 sets the location of the relevant organization selected by the main controller 370 in accordance with the emergency situation into an authentication zone T2 and preliminary zones G1 and G2. The urgency and importance of authentication in an emergency situation can be set to a high point.

The main controller 370 monitors the current location and route of the vehicle 10, and when the vehicle 10 that is autonomously driven enters the first preliminary zone G1, the main controller 370 informs the authentication system 368 of entering of the vehicle (S202).

While the vehicle 10 is autonomously driven in the first preliminary zone G1, the authentication system 368 attempts authentication through a passenger through primary control. The authentication system 368 can determine authentication availability by determining the urgency and importance of authentication (S203). For example, when there is no response from the passenger after an attempt of authentication through the passenger in the first preliminary zone G1, the authentication system 368 can immediately perform authentication through data from past authentication information of the passenger or can attempt authentication through an agent (or guardian) of the passenger.

The main controller 370 monitors the current location and route of the vehicle 10, and when the vehicle 10 that is autonomously driven enters the second preliminary zone G2, departing from the existing route R, the main controller 370 informs the authentication system 368 of entering of the vehicle (S204).

While the vehicle 10 is autonomously driven in the second preliminary zone G2, the authentication system 368 attempts authentication to the passenger through secondary control. In the secondary control, a user interface device may be added or the output intensity may be increased in comparison to the primary control. When failing in authentication through the passenger in the second preliminary zone G2, the authentication system 368 reserves an emergency service (emergency room) by transmitting passenger information to a relevant organization, for example, a hospital (S205).

The main controller 370 monitors the current location and route of the vehicle 10, and when the vehicle 10 that is autonomously driven arrives at the authentication zone T2, the main controller 370 informs the authentication system 368 of arrival of the vehicle (S206).

When the vehicle 10 arrives the authentication zone T2, the authentication system 368 attempts authentication again to the passenger through third control. When determining that direct authentication through the passenger is impossible even after arriving at the authentication zone T2, the authentication system 368 selects data necessary for authentication from stored past authentication information of the passenger or an agent or past authentication information received from a network, performs authentication on the basis of the data, and then transfers the passenger to the corresponding relevant organization so that the passenger is provided with an emergency service (S207).

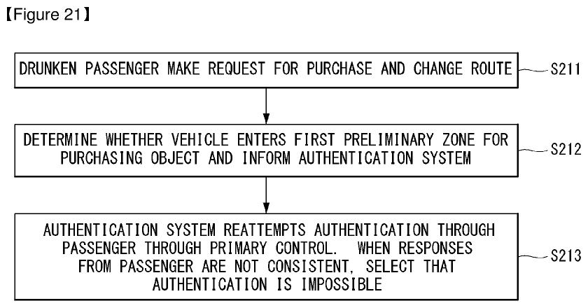

Referring to FIG. 21, a drunken passenger may make a request for purchase in an autonomous vehicle. The request for purchase by a drunken passenger may be low in reliability. The main controller 370 can change the route to the authentication zone in accordance with the request for purchase from the passenger (S211). The main controller 370 can determine that the passenger who made the request for purchase is a drunken passenger by determining the state of the passenger through the AI agent, and can input the state of the passenger to the authentication system 368. A relatively low point may be set in urgency and importance for the event that the drunken passenger generated.

The main controller 370 monitors the current location and route of the vehicle 10, and when the vehicle 10 that is autonomously driven enters the first preliminary zone G1, the main controller 370 informs the authentication system 368 of entering of the vehicle (S212).

While the vehicle 10 is autonomously driven in the first preliminary zone G1, the authentication system 368 attempts authentication through the drunken passenger through primary control. The authentication system 368 can determine authentication availability by determining the urgency and importance. For example, when there is no response from the passenger or responses from the passenger are not consistent in an attempt for authentication through the drunken passenger in the first preliminary zone G1, the authentication system 368 can determine that authentication is impossible (S213).

When checking a request for purchase, the authentication system 368 can accumulate 1 when the specifications of the request for purchase are correct, subtract 1 when the specifications are incorrect (NOK), and accumulate 0 when the specifications are unknown. The authentication system 368 can repeatedly check the specifications of a request for purchase from a passenger and can determine validity of responses from the passenger on the basis of accumulated points.

The authentication system 368 can provide the authentication agency service even though a passenger purchases a product or a service, which can be provided in a vehicle, and authentication through the passenger is impossible. In this case, since the authentication zone is the vehicle 10, it is possible to attempt authentication through the passenger for a predetermined time without Geofencing, and when direct authentication of the passenger is failed, it is possible to perform authentication on the basis of data selected from past authentication information of the passenger or an agent.

An autonomous vehicle and an authentication agency method thereof of the present invention may be described as follows.

An autonomous vehicle of the present invention includes: a controller 370 that outputs a location and a route of the vehicle when an event requiring authentication of a passenger occurs; and an authentication system 368 that sets a preliminary zone on the basis of the location and the route of the vehicle input from the controller, attempts direct authentication of the passenger in the preliminary zone, and performs authentication on the basis of data stored in advance or data received through a network after arriving at an authentication zone outside the vehicle when direct authentication of the passenger is failed. The authentication zone includes a store or an organization where the event is finished.

The authentication system repeatedly attempts authentication to the passenger through a user interface device in the vehicle in the preliminary zone, and increases control intensity for an authentication attempt by adding the user interface device or increasing output intensity of the user interface device as the vehicle comes close to the authentication zone.

The authentication system changes the size of the preliminary zone in accordance with urgency and importance of the event requiring authentication of a passenger.

The preliminary zone includes: a first preliminary zone; and a second preliminary zone defined between the first preliminary zone and the authentication zone. The first preliminary zone includes an existing route before being changed into a post-change route to the authentication zone. The second preliminary zone includes a post-change route to the authentication zone.

The event requiring authentication of a passenger includes a request for purchasing a product or a service from the passenger.

The authentication system attempts authentication through the passenger using a user interface device in the first preliminary zone, attempts authentication through the passenger using the user interface device in the second preliminary zone, and makes an appointment for purchase by transmitting order information of the passenger to a store in the authentication zone when determining that authentication through the passenger is impossible.

The controller determines the state of the passenger by analyzing images from a camera in the vehicle and provides data indicating the state of the passenger to the authentication system.

The authentication system sets the preliminary zone when the state of the passenger is a state in which direct authentication of the passenger is difficult or impossible.

The event requiring authentication of a passenger includes an emergency situation in which an abnormal state of the passenger is sensed.

The authentication system attempts authentication through the passenger using a user interface device in the first preliminary zone, attempts authentication through the passenger using the user interface device in the second preliminary zone, and makes an appointment for an emergency service by transmitting information of the passenger to a relevant organization when determining that authentication through the passenger is impossible. The authentication system performs authentication on the basis of data selected from past authentication information of the passenger or an agent of the passenger in the authentication zone.

An authentication agency method of an autonomous vehicle includes: setting a preliminary zone on the basis of a location and a route of the vehicle when an event requiring authentication of a passenger occurs; and attempting direct authentication of the passenger in the preliminary zone and performing authentication on the basis of data stored in advance or data received through a network after arriving at an authentication zone outside the vehicle when direct authentication of the passenger is failed. The authentication zone is an area including a store or an organization where the event is finished.

The authentication agency method of an autonomous vehicle further includes: repeatedly attempting authentication to the passenger through a user interface device in the vehicle in the preliminary zone; and increasing control intensity for an authentication attempt by adding the user interface device or by increasing output intensity of the user interface device as the vehicle comes close to the authentication zone.

The authentication agency method of an autonomous vehicle further includes changing the size of the preliminary zone in accordance with urgency and importance of the event requiring authentication of a passenger.

The authentication agency method of an autonomous vehicle further includes setting the preliminary zone into a first preliminary zone and a second preliminary zone defined between the first preliminary zone and the authentication zone. The first preliminary zone includes an existing route before being changed into a post-change route to the authentication zone. The second preliminary zone includes a post-change route to the authentication zone.

The authentication agency method of an autonomous vehicle further includes further increasing control intensity of an authentication attempt by adding the user interface device or increasing output intensity of the user interface device in the second preliminary zone in comparison to the first preliminary zone.

The authentication agency method of an autonomous vehicle further includes: attempting authentication through the passenger using a user interface device in the first preliminary zone; attempting authentication through the passenger using the user interface device in the second preliminary zone; and making an appointment for purchase by transmitting order information of the passenger to a store in the authentication zone when determining that authentication through the passenger is impossible.

The authentication agency method of an autonomous vehicle further includes determining the state of the passenger by analyzing images from a camera in the vehicle.

The authentication agency method of an autonomous vehicle further includes: attempting authentication through the passenger using a user interface device in the first preliminary zone; attempting authentication through the passenger using the user interface device in the second preliminary zone, and making an appointment for an emergency service by transmitting information of the passenger to a relevant organization when determining that authentication through the passenger is impossible; and performing authentication on the basis of data selected from past authentication information of the passenger or an agent of the passenger in the authentication zone.

The present invention can be achieved by computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present invention should be determined by reasonable analysis of the claims and all changes within an equivalent range of the present invention is included in the scope of the present invention.

1. An autonomous vehicle comprising:
a controller that outputs a location and a route of the vehicle when an event requiring authentication of a passenger occurs; and
an authentication system that sets a preliminary zone on the basis of the location and the route of the vehicle input from the controller, attempts direct authentication of the passenger in the preliminary zone, and performs authentication on the basis of data stored in advance or data received through a network after arriving at an authentication zone outside the vehicle when direct authentication of the passenger is failed,
wherein the authentication zone is an area including a store or an organization where the event is finished.

2. The autonomous vehicle of claim 1, wherein the authentication system repeatedly attempts authentication to the passenger through a user interface device in the vehicle in the preliminary zone, and increases control intensity for an authentication attempt by adding the user interface device or increasing output intensity of the user interface device as the vehicle comes close to the authentication zone.

3. The autonomous vehicle of claim 1, wherein the authentication system changes the size of the preliminary zone in accordance with urgency and importance of the event requiring authentication of a passenger.

4. The autonomous vehicle of claim 2, wherein
the preliminary zone includes: a first preliminary zone; and a second preliminary zone defined between the first preliminary zone and the authentication zone,
the first preliminary zone includes an existing route before being changed into a post-change route to the authentication zone, and
the second preliminary zone includes a post-change route to the authentication zone.

5. The autonomous vehicle of claim 4, wherein the event requiring authentication of a passenger includes a request for purchasing a product or a service from the passenger.

6. The autonomous vehicle of claim 5, wherein the authentication system attempts authentication through the passenger using a user interface device in the first preliminary zone, attempts authentication through the passenger using the user interface device in the second preliminary zone, and makes an appointment for purchase by transmitting order information of the passenger to a store in the authentication zone when determining that authentication through the passenger is impossible.

7. The autonomous vehicle of claim 4, wherein the controller determines the state of the passenger by analyzing images from a camera in the vehicle and provides data indicating the state of the passenger to the authentication system.

8. The autonomous vehicle of claim 7, wherein the authentication system sets the preliminary zone when the state of the passenger is a state in which direct authentication of the passenger is difficult or impossible.

9. The autonomous vehicle of claim 8, wherein the event requiring authentication of a passenger includes an emergency situation in which an abnormal state of the passenger is sensed.

10. The autonomous vehicle of claim 9, wherein the authentication system attempts authentication through the passenger using a user interface device in the first preliminary zone, attempting authentication through the passenger using the user interface device in the second preliminary zone, making an appointment for an emergency service by transmitting information of the passenger to a relevant organization when determining that authentication through the passenger is impossible, and performs authentication on the basis of data selected from past authentication information of the passenger or an agent of the passenger in the authentication zone.

11. An authentication agency method of an autonomous vehicle, the authentication agency method comprising:
setting a preliminary zone on the basis of a location and a route of the vehicle when an event requiring authentication of a passenger occurs; and
attempting direct authentication of the passenger in the preliminary zone and performing authentication on the basis of data stored in advance or data received through a network after arriving at an authentication zone outside the vehicle when direct authentication of the passenger is failed,
wherein the authentication zone is an area including a store or an organization where the event is finished.

12. The authentication agency method of claim 11, further comprising:
repeatedly attempting authentication to the passenger through a user interface device in the vehicle in the preliminary zone; and
increasing control intensity for an authentication attempt by adding the user interface device or by increasing output intensity of the user interface device as the vehicle comes close to the authentication zone.

13. The authentication agency method of claim 11, further comprising changing the size of the preliminary zone in accordance with urgency and importance of the event requiring authentication of a passenger.

14. The authentication agency method of claim 12, further comprising setting the preliminary zone into a first preliminary zone and a second preliminary zone defined between the first preliminary zone and the authentication zone,
wherein the first preliminary zone includes an existing route before being changed into a post-change route to the authentication zone, and
the second preliminary zone includes a post-change route to the authentication zone.

15. The authentication agency method of claim 14, further comprising: further increasing control intensity of an authentication attempt by adding the user interface device or increasing output intensity of the user interface device in the second preliminary zone in comparison to the first preliminary zone.

16. The authentication agency method of claim 15, wherein the event requiring authentication of a passenger includes a request for purchasing a product or a service from the passenger.

17. The authentication agency method of claim 16, further comprising:
attempting authentication through the passenger using a user interface device in the first preliminary zone; attempting authentication through the passenger using the user interface device in the second preliminary zone; and
making an appointment for purchase by transmitting order information of the passenger to a store in the authentication zone when determining that authentication through the passenger is impossible.

18. The authentication agency method of claim 14, further comprising determining the state of the passenger by analyzing images from a camera in the vehicle.

19. The authentication agency method of claim 18, further comprising setting the preliminary zone when the state of the passenger is a state in which direct authentication of the passenger is difficult or impossible.

20. The authentication agency method of claim 19, further comprising:
attempting authentication through the passenger using a user interface device in the first preliminary zone;
attempting authentication through the passenger using the user interface device in the second preliminary zone, and making an appointment for an emergency service by transmitting information of the passenger to a relevant organization when determining that authentication through the passenger is impossible; and
performing authentication on the basis of data selected from past authentication information of the passenger or an agent of the passenger in the authentication zone.
